(19) United States
(12) Patent Application Publication
(10) Pub. No.: US 2007/0141539 A1
(43) Pub. Date: Jun. 21, 2007

(54) Educational method for improving dietary habits

(76) Inventor: Veronique Lemieux, Montreal (CA)

Correspondence Address: Philip Swain PhD, 4601 HAMPTON AVENUE, MONTREAL, QC, H4A 2L5, CA

(21) Appl. No.: 11/487,502

(22) Filed: Jul. 17, 2006

Related U.S. Application Data
(60) Provisional application No. 60/741,546, filed on Dec. 2, 2005.

(51) Int. Cl. G09B 19/18

(52) U.S. Cl. 434/107

(57) ABSTRACT

The invention provides an educational method for increasing a subject's skill in human nutrition science from a first low skill level to a second high skill level. The method comprises enrolling the subject in one education pathway with one or more skill levels therein. Each skill level has one or more educational goals associated with it, the knowledge levels increase as the subject progresses along the education pathway. Another education pathway is provided and operates simultaneously and progressively with the first education pathway. The other education pathway has associated with it at least one nutrition educating session, which is adapted to achieve at least one of the educational goals. The successful completion of the educational goal allows the subject to move to the next skill level in the first education pathway, thereby increasing the subject's knowledge and skill in human nutrition science.

### CROSS-REFERENCE TO RELATED APPLICATION

Applicant hereby claims priority from U.S. provisional patent application, Ser. No. 60/741,546, filed on Dec. 2, 2005, the entire contents of which are hereby incorporated by reference in their entirety.

### FIELD OF THE INVENTION

The present invention concerns an educational method for improving the dietary habits of a subject, particularly a human subject.

### BACKGROUND OF THE INVENTION

Making healthy lifestyle choices are important in maintaining ones good health and general wellness. It is well documented that an unhealthy lifestyle can increase the risk of developing health problems in humans, such as obesity, coronary heart disease, diabetes, cancer, and the like, and the complications often associated therewith. The management of such diseases places a considerable burden on the health care system and on the immediate family members of the disease sufferer, and can lead to premature death of the person. Most diseases that result from an unhealthy lifestyle are, for the most part, preventable if the person can change their unhealthy lifestyle habits. One problem that many people face, including physicians, is the lack of time and resources available to them to educate people about health issues and how to maintain their health. Such health issues include, for example, diseases, risk factors that cause diseases, disease treatment, possible complications with the diseases, and prevention of the diseases.

Educating people is very important to help them to comply with lifestyle changes, such as changing dietary habits. The overwhelming amount of healthcare information that is available via the mass media is typically information about nutritional choices. This information is confusing to some and if followed without adequate supervision by a nutritionist may, in some cases, lead to an increase in unhealthy food choices in an otherwise unhealthy lifestyle. There therefore is a need to improve the dissemination of information to motivated individuals about eating for both health and pleasure, which will lead to deceased health care costs and increased health benefits such as increased life expectancy, improved quality of life, prevention of certain diseases and their complications.

A systematic learning experience, if it is provided in a relaxed and interactive atmosphere, and under the supervision of a nutritionist/dietician or other health care professional, will make healthy food choices more entertaining to the person and would undoubtedly provide a significantly reduced incidence of recidivism.

Several methods and systems have been designed to address the issues of changing dietary habits, motivation and compliance therewith. A number of examples are given below:
U.S. Pat. No. 6,269,339, issued on Jul. 31, 2001, to Silver;
U.S. Pat. No. 6,151,586, issued on Nov. 21, 2000, to Brown;
U.S. Pat. No. 5,933,136, issued on Aug. 3, 1999, to Brown;
U.S. Pat. No. 5,908,301, issued on Jun. 1, 1999, to Lutz;
U.S. Pat. No. 4,464,122, issued on Aug. 7, 1984, to Fuller et al.;
U.S. published patent application No. 2005/0113649, published on May 26, 2005, to Bergantino;
U.S. published patent application No. 2005/0060194, published on Mar. 17, 2005, to Brown;
U.S. published patent application No. 2005/0021372, published on Jan. 27, 2005, to Mikkelsen;
U.S. published patent application No. 2004/0267565, published on Dec. 30, 2004, to Grube;
U.S. published patent application No. 2004/0010420, published on Jan. 15, 2004, to Rooks;
U.S. published patent application No. 2003/0220814, published on Nov. 27, 2003, to Gordon;
U.S. published patent application No. 2003/0204412, published on Oct. 30, 2003, to Brier;
U.S. published patent application No. 2003/0065561, published on Apr. 3, 2003, to Brown et al.; and
U.S. published patent application No. 2002/0055857, published on May 9, 2002, to Mault.

The aforesaid designs, however, suffer from a number of important disadvantages. A number of the designs are complicated and require laborious form filling by the person, which may be de-motivating to some people. Many of the methods are solely computer based, are very controlling and require strict compliance with the method steps. One method uses a client's physiological age as a reference point to determine an optimum health index, but this may include unacceptably high margins of error and assumes that physiological age is the only indicator of health. The methods often lack educational and pleasurable experiences, and human interaction, as part of a motivational process and success. Not only may the use of a computer be prohibitively expensive to some people, but also may require learning a new skill set, which can be time consuming.

Thus there is a need for an improved method and system for educating a person about how to make the correct nutritional choices for foods, the result of which would provide a positive effect on overall health, well being, and possibly an increased lifespan with fewer preventable diseases due to poor diet management.

### SUMMARY OF THE INVENTION

The present invention addresses the aforesaid problems of unhealthy diet, lifestyle and lack of knowledge, motivation and compliance, by providing a novel and unobvious nutrition educational method and system. A person, or persons, who wish to modify their nutrition/diet behavior, can enroll in the method during which they are simultaneously exposed to two nutrition education pathways. Whilst participating in the method, the subject's knowledge of, and skills in, human nutrition science and general health matter progressively increases. Advantageously, the method provides the person with a systematic learning experience that is progressive and entertaining, and has a low rate of recidivism, when compared to the aforesaid methods, and is free from peer pressure.

Moreover, the long-term benefits of a person being enrolled in the method are that there would be a noticeable decrease in health care costs both to the person and to the health care insurers, and a significant increase in their motivation to comply with the knowledge skills learnt in the method of the present invention. A further advantage of the modified nutrition/diet behavior would be a reduction in the incidence of obesity and problems associated therewith such as, for example, adult onset diabetes.

Accordingly in one embodiment of the present invention, there is provided an educational method for increasing a subject's skills in human nutrition science from a first low skill level to a second high skill level, the method comprising:
a) enrolling the subject in a first education pathway having one or more skill levels therein, each skill level having one or more educational goals associated therewith, the skill levels increasing as the subject progresses along the first education pathway;
b) providing the subject with at least a second education pathway, the second education pathway operating simultaneously and progressively with the first education pathway, the second education pathway having associated therewith at least one nutrition educating session adapted to achieve at least one of the educational goals, the successful completion of the educational goal allowing the subject to move to the next skill level in the first education pathway, thereby increasing the subject's skills in human nutrition science.

One aspect of this method further including evaluating the subject's successful completion of the education goal by:
c) providing the subject in the at least a second education pathway having therein a main objective, at least one workshop, and a skills assessment, the successful completion of the main objective, the workshop, and the skills assessment being sufficient to allow the subject to move from the first skill level to the second skill level.

In another aspect of this method, the subject is assessed using a progress evaluation grid. In another aspect of this method, an evaluation questionnaire is used to determine the first skill level of the subject. In another aspect of this method an electronic database is maintained in which data from an evaluation questionnaire is entered, the data being used to determine the first skill level of the subject.

In another aspect of this method an electronic database is maintained in which data from an evaluation questionnaire and/or nutritional assessment are entered, the data being used to create a subject profile. In various aspects of this method the evaluation questionnaire scores the subject on skills in human nutrition science, the skills including nutrition, human anatomy and physiology, medicine, food choice, or eating pleasure. In another aspect of this method, the score is entered into the database, the score correlating with the subject's first skill level. The database includes an idealized skill profile to which the first skill level is compared. The nutritional assessment comprises a nutritional evaluation, a medical history evaluation, a family medical history evaluation, a weight evaluation, a height evaluation, a Body Mass Index (BMI) evaluation, a nutritional risk evaluation and a nutritional status evaluation of the subject. In one aspect of this method the first education pathway includes a group lesson or a private lesson. In another aspect of this method the first education pathway includes two or more and twenty or less nutritional skill levels. In another aspect of this method the first education pathway includes two or more and twenty or less nutritional skill levels, the skill levels increasing in sophistication as the levels increase. In another aspect of this method the first education pathway includes five levels of nutritional skill, the subject acquiring increased skills as they progress along the first education pathway. In another aspect of this method the first education pathway includes five levels of nutritional skill, at least one of the levels including the at least one second education pathway. In another aspect of this method, the first education pathway includes five levels of nutritional skill, each of the five levels further including respectively third, fourth, fifth and sixth education pathways. Each level includes a level main objective. In another aspect of this method the first education pathway includes five levels of nutritional skill, each of the five levels including five education pathway goals. The education pathway goals include pleasure of eating, human anatomy and physiology, medicine, nutrition science and food knowledge. In another aspect of this method the second education pathway includes at least one education session. The second nutrition education pathway includes six education sessions. Each education session includes a session main objective. Each session further includes first and second tasting sessions, a skills development, homework, and a workshop. In another aspect of this method the skill of the subject is measured by the subject's ability to read and understand a nutritional information label on a food product so as to make a healthy food choice.

According to another embodiment of the present invention, there is provided an educational method for increasing a subject's skills in human nutrition science, the method comprising:
a) providing an evaluation questionnaire to the subject;
b) electronically creating a subject database by electronically adding a subject's responses to the evaluation questionnaire stored in the database;
c) electronically creating a first skill profile of the subject by analyzing the responses to the questionnaire;
d) enrolling the subject in a first nutrition education pathway based on the first skill profile;
e) providing the subject with at least a second education pathway, the second education pathway operating simultaneously and progressively with the first education pathway, the second education pathway having associated therewith at least one nutrition educating session adapted to achieve at least one of the educational goals;
f) electronically maintaining the subject's database by electronically inputting the subject's achievements of the at least one educational goal, the subject achieving a second skill profile; and
g) comparing the subject's first skill profile with the second skill profile, an increase in the nutritional skill of the subject being an indication of increased skill in human nutrition science.

In one aspect of this method an evaluation questionnaire is used to determine the first skill level of the subject. In another aspect of this method an electronic database is maintained in which data from an evaluation questionnaire is entered, the data being used to determine the first skill level of the subject. In another aspect of this method an electronic database is maintained in which data from an evaluation questionnaire and/or nutritional assessment are entered, the data being used to create a subject profile. In various aspects of this method the evaluation questionnaire scores the subject on skill of human nutrition science, the skill including nutrition, human anatomy and physiology, medicine, food choice, or eating pleasure. In another aspect of this method the score is entered into the database, the score correlating with the subject's first skill level. In another aspect of this method the database includes an idealized skill profile to which the first skill level is compared. In another aspect of this method the first education pathway includes a group lesson or a private lesson. In another aspect of this method the nutritional assessment comprises a nutritional evaluation, a medical history evaluation, a family medical history evaluation, a weight evaluation, a height evaluation, a Body Mass Index (BMI) evaluation, a nutritional risk evaluation and a nutritional status evaluation of the subject. In another aspect of this method the first education pathway includes two or more and twenty or less nutritional skill levels. In another aspect of this method the first education pathway includes two or more and twenty or less nutritional skill levels, the skill levels increasing in sophistication as the levels increase. In another aspect of this method the first education pathway includes five levels of nutritional skill, the subject acquiring an increased skill as they progress along the first education pathway. In another aspect of this method the first education pathway includes five levels of nutritional skill, at least one of the levels including the at least one second education pathway. In another aspect of this method the first education pathway includes five levels of nutritional skill, each of the five levels further including respectively third, fourth, fifth and sixth education pathways. Each level includes a level main objective. In another aspect of this method the first education pathway includes five levels of nutritional skill, each of the five levels including five education pathway goals. In another aspect of this method the education pathway goals include pleasure of eating, human anatomy and physiology, medicine, nutrition science and food knowledge. In another aspect of this method the second education pathway includes at least one education session. In another aspect of this method the second nutrition education pathway includes six education sessions. Each education session includes a session main objective. Each session further includes first and second tasting sessions, a skills development, homework, and a workshop. In another aspect of this method the skill of the subject is measured by the subject's ability read and understand a nutritional information label on a food product so as to make a healthy food choice.

According to another embodiment of the present invention, there is provided a computer-readable storage medium having a data storage material encoded with the computer implemented steps of b), c) and f), as described above.

According to another embodiment of the present invention there is provided a computer system for generating a human nutrition science skill profile of a subject, the system comprising: a computer readable storage medium including a data storage material encoded with the computer implemented steps of b), c), and f), as described above; a memory for storing instructions for processing the data; a central processing unit coupled to the computer-readable storage medium for processing the computer readable data into the nutritional skill profile of the subject; and a display unit coupled to the central processing unit for displaying the profile.

According to another embodiment of the present invention, there is provided an educational system for increasing a subject's knowledge of human nutrition science, the system comprising: a computer readable storage medium for implementing steps of b), c) and f), as described above; a memory for storing instructions for processing the data; c) a central processing unit coupled to the computer-readable storage medium for processing the computer readable data into the nutritional skill profile of the subject; a display unit coupled to the central processing unit for displaying the profile; and means for providing feedback to the subject to allow them to participate in a third, fourth, fifth or sixth nutrition education pathway. In one aspect of this system, the computer system is accessible from the Internet.

According to another embodiment of the present invention, there is provided an educational system for increasing a subject's skill in human nutrition science, the system comprising:
a) an evaluation questionnaire for evaluating a first nutritional skill level of the subject;
b) an electronic database for electronically maintaining the skill level profile for the subject, the database having therein an idealized skill profile;
c) a first education pathway having one or more skill levels therein, each skill level having a plurality of educational goals associated therewith, the skill levels increasing as the subject moves along the first education pathway;
d) a second education pathway, the second education pathway operating simultaneously with the first education pathway, the second education pathway having associated therewith at least one nutrition educating session adapted to achieve the educational goals, the successful completion of the goals being compared to the idealized skill profile, the matching of which allows the subject to move to the next skill level in the first education pathway, thereby increasing the subject's skill in human nutrition science.

According to another embodiment of the present invention there is provided an education method for improving dietary habits of a human subject, the method comprising:
a) enrolling the subject in a first education pathway having one or more skill levels therein, each skill level having one or more educational goals associated therewith, the skill levels increasing as the subject progresses along the first education pathway;
b) providing the subject with at least a second education pathway, the second education pathway operating simultaneously and progressively with the first education pathway, the second education pathway having associated therewith at least one nutrition educating session adapted to achieve at least one of the educational goals, the successful completion of the educational goal allowing the subject to move to the next skill level in the first education pathway, thereby improving the subject's dietary habits.

In one aspect of this method the improvement of dietary habits are measured by weight loss, improved weight management,, cholesterol management, diabetes management, or prevention of cancer.

In various aspects of this method the method is remotely accessible. In another aspect of this method the remote access is interactive. In another aspect of this method the remote access is by a webcam or video conference.

In another embodiment of the present invention, there is provided a use of the system, as described above, for increasing a subject's skill in human nutrition science.

### BRIEF DESCRIPTION OF THE DRAWINGS

Further aspects and advantages of the present invention will become better understood with reference to the description in association with the following Figures, wherein:

FIG. 1 is a flow diagram showing a method and system of the present invention;

FIG. 2 illustrates a file form for creating a subject database;

FIG. 3 illustrates a knowledge (or skill) level evaluation questionnaire for evaluating the subject's knowledge of, or skills in, human nutrition science;

FIG. 4 is a schematic representation illustrating two simultaneously operating nutrition education pathways between a first low knowledge (or skill) level and a second higher knowledge (skill) level;

FIG. 5 is a schematic representation a first nutrition educational pathway in accordance with an embodiment of the present invention;

FIG. 6 is a detailed schematic representation of the first education pathway of FIG. 5 operating simultaneously and progressively with a plurality of other education pathways;

FIG. 7 is a diagram illustrating a number of educational goals within the first education pathway;

FIG. 8 is a flow diagram of the second nutrition education pathway showing six learning sessions;

FIG. 9 is illustrates a round table education session and different topic examples;

FIG. 10 is a consultation form printout for a subject enrolled in a private counseling choice;

FIG. 11 illustrates a clinical examination form printout for the subject enrolled in the private counseling choice of FIG. 10;

FIG. 12 illustrates a dietary journal for nutrition intake on a 24 hour basis for the subject of FIG. 10;

FIG. 13 illustrates a subject analysis form printout for the subject of FIG. 10;

FIG. 14 illustrates a food evaluation grid; and

FIG. 15 illustrates a subject's progress evaluation grid.

### DETAILED DESCRIPTION OF THE INVENTION

Definitions

Unless otherwise specified the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus the phrase “consisting of” indicates that the listed elements are required or mandatory and that no other elements may be present.

As used herein, the term “skills” when used in combination with human nutrition science is intended to mean that the human subject has sufficient knowledge in human nutrition science and technique to be able to perform a task or activity consistently over a period of time. The expertise required for a particular task or occupation which may include manual dexterity and/or mental aptitude and/or creativity. This definition encompasses the ability of the subject to differentiate between physiological appetite signals, such as stomach rumbling and salivation, and psychological appetite, such as external stimulation like food company advertising, peer pressure, emotion eating and impulse eating. One example of a skill is the subject's ability to read and understand a nutritional information label on a food product, being able to compare the product with a similar one, and as such make a healthier food choice.

Generally speaking, the present invention is a method for increasing a motivated human subject's knowledge of human nutrition science from a basic low level to an advanced level by providing the subject with two or more educational pathways that operate simultaneously and progressively with a first main education pathway. Increasing the subject's knowledge of, or skills in, human nutrition science has many immediate and long term benefits such as changing dietary habits, positively impacting health, weight loss and weight management, changing choices of food and its preparation. Moreover, the method and system of the present invention can be fully integrated with traditional teaching methods and tools such as, for example, the use of instructional videos, books and the like. Experiences during the method of the present invention mimic real life, such as the use of restaurants to positively reinforce the lessons learnt in tasting sessions, which are described in more detail below.

The subject is first evaluated on their needs and knowledge using an evaluation grid or questionnaire, the results of which help to classify the person by their knowledge of, or skills in, human nutrition science. The learning experience, being a pathway, progressively upgrades the subject's knowledge from a limited knowledge level to an advocate (advanced) knowledge level, although how the subject progresses along the pathway is unrestricted. To accomplish the progression, the first pathway includes a number of levels of learning. Each level comprises another pathway, which is integrated with the first pathway and operates simultaneously therewith, and includes, in series, a number of goal-orientated interactive sessions, designed to positively reinforce the skills and abilities learnt in the sessions. Advantageously, a number of food tasting sessions focus on the discovery of new foods and on improving the dietary habits through taste, which is highly motivating. The goals of each session may initially include very basic objectives of learning such as, for example, having the person understand the impact of food choices on their health. One session, coached by the nutritionist/dietician, may include an exercise (or workshop), which is used to link dietary habits with a disease caused by such habits, for example, adult onset diabetes. The person participates in all sessions until the person successfully completes the first level. As the person progresses through the first pathway, the nutritionist progressively evaluates the person at each level from lesson 1 to 6 in the second pathway. The evaluation is based on the person's progress, the participation of the subject in the sessions and the behavioral changes observed through the second pathway of the level. The evaluation process allows the person to move to the next level of the first pathway. If the person requires adjustments to successfully accomplish the level, a private session with a nutritionist may be offered in private counseling.

As the person progresses along the first pathway, each subsequent level, and other pathway therein, provides the person with opportunities to increase their knowledge in the pleasures of eating (for example, discovering international food), anatomy and physiology (for example, the digestive system), medicine (for example, diseases such as cancer, risk factors associated therewith, complications, prevention thereof), nutrition science (for example, antioxidants and their role in preventing cancer) and food choices (for example, eating wheat germ for vitamin E, a known antioxidant). The further along the first pathway the person progresses, the more complex and sophisticated the sessions become. The sessions in the second pathway are all designed the same way: Session 1: level presentation; Session 2: food tasting; Session 3: restaurants; Session 4: workshop; Session 5: art of cooking; and Session 6: fiesta. Each session includes a main objective, two tasting sessions, a workshop and abilities testing. The number of the sessions however is unrestricted and may be increased or decreased as desired. The participant in the method may receive a reward such as a diploma or badge at the final session of a level, which will accentuate their compliance and the desire to proceed further in the accomplishment of the first nutrition education pathway.

The ultimate goal is to educate the person from a limited understanding to good understanding, through experience changes, and on expanding on changes in dietary habit sufficiently so that they become advocates for the method. The method of the present invention provides useful, concrete and tangible results by significantly reducing the rate of recidivism in the enrollees. In practice, the method is used as part of a system that includes a computer interface as part of the system to store a person's personal data and progress by providing on-screen or printout reports.

Advantageously, the educational method and system of the present invention provides subjects a progressive, flexible, yet efficient way to learn and lead a person to a healthy lifestyle with dietary habits through a number of motivational lessons that can be maintained for life. The sessions are very interactive through tasting sessions, workshops and the development of abilities or skills, which advantageously increases the retention of learnt material and compliance with a healthy lifestyle. This makes it easy for the person to implement changes at home and keep them long term. The learning is provided to the subject in an environment that is free from peer pressure and misinformation. This significantly reduces the rate of recidivism due to de-motivation by reinforcing positive and healthy lifestyles. An additional advantage of the educational pathway is that the subject may choose between private sessions level (from 1 to 4 people, for example 2 parents and 2 children) and a group session level (a mixture of from 4 to 6 people), which is designed to encourage learning through group participation and provides group support. One skilled in the art will readily understand that the number of people enrolled in the sessions, however, may vary.

It is also contemplated within the scope of the present invention that the use of so-called “alternative medicine” techniques such as, for example, herbal remedies, natural products and the like, are also compatible with the method and system described herein.

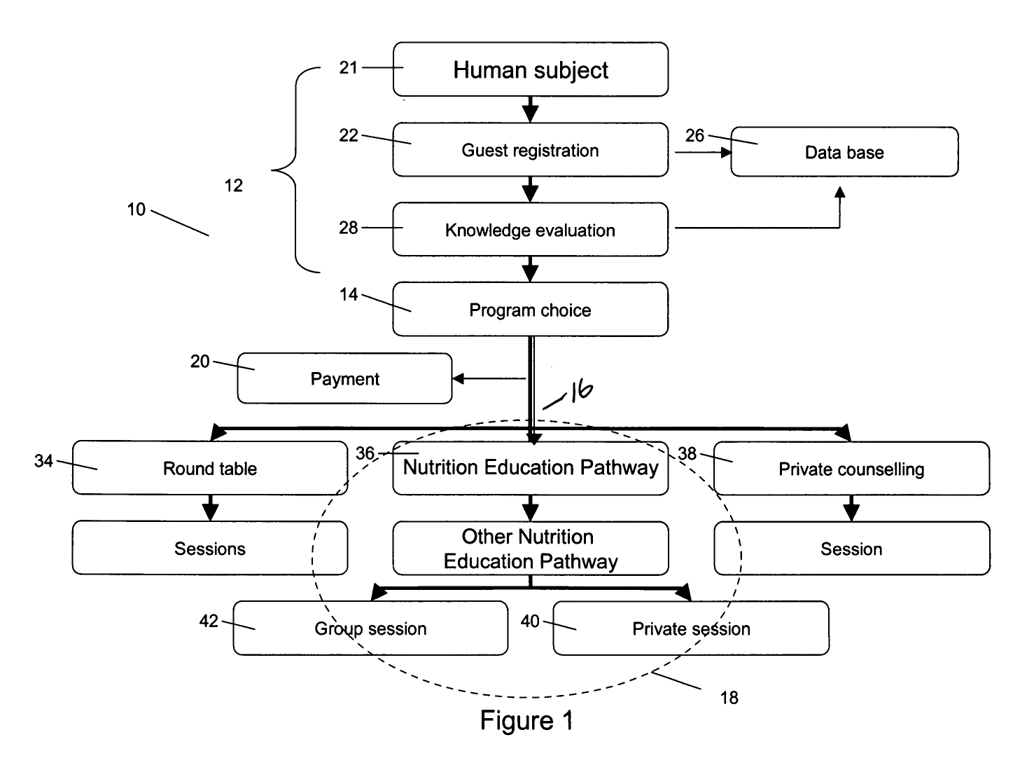

Referring now to FIG. 1, a flow diagram generally illustrates the method and system of the present invention at 10, and broadly speaking includes an assessment phase 12, a program choice phase 14, an enrollment phase 16, and an execution phase 18. A payment phase 20 is typically present after the program choice phase 14 before commencement of the execution phase 18.

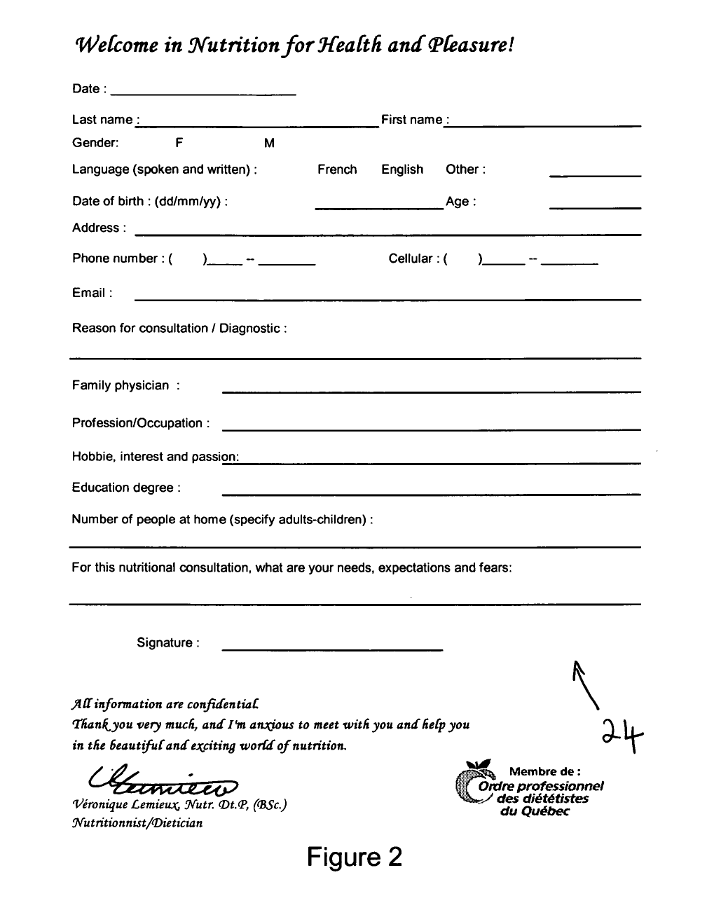

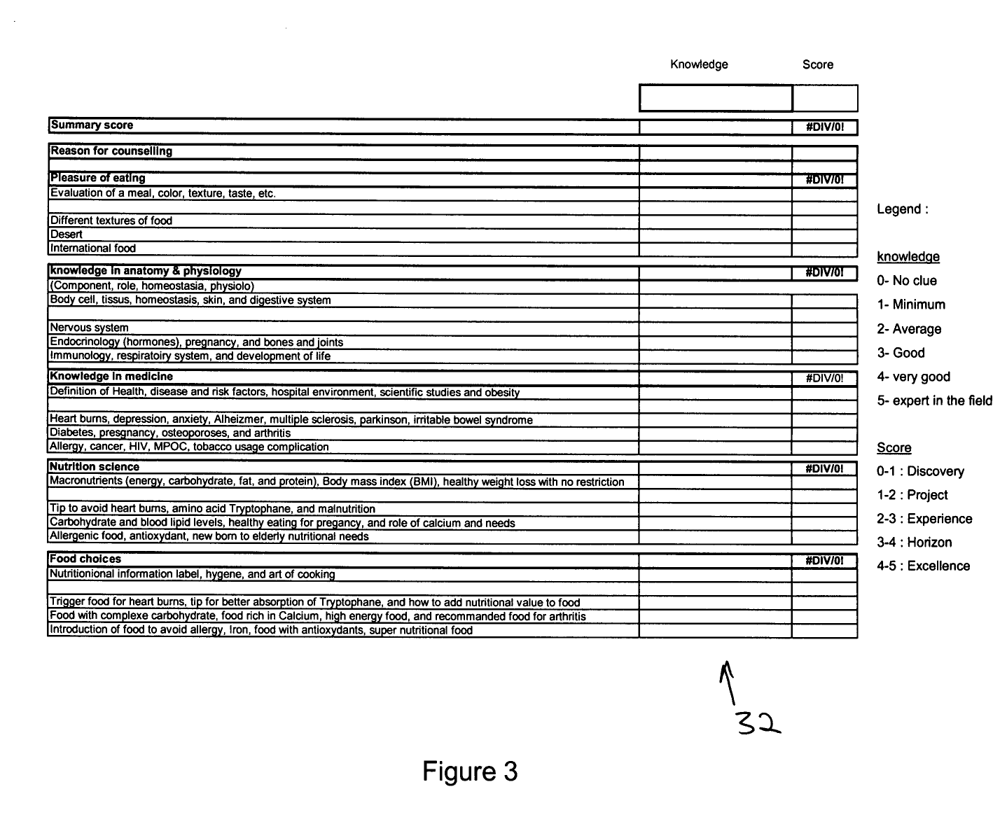

As best illustrated in FIGS. 1, 2 and 3, a human subject (or patient) 21, who wishes to improve their knowledge or skill in nutrition science and dietary habits, would present themselves at a dietician's (or nutritionist's) office for guest registration 22 at the start of the assessment phase 12. At guest registration 22 the subject 21 completes a file form 24, the contents of which are electronically entered into an electronic database 26 and stored on an computer readable medium such as, for example, a computer hard drive, floppy disk, CD-ROM and the like. The computer-readable medium (or data storage material) may be encoded with the method steps of the invention to either monitor the progress of the subject or as an aide to the nutritionist. The computer may include a memory for storing instructions for processing the subject's data; a central processing unit coupled to the computer-readable storage medium for processing the computer readable data into the nutritional knowledge profile of the subject; and a display unit coupled to the central processing unit for displaying the profile. The database 26 may be accessed and electronically maintained by the nutritionist to retrieve information about the subject. Furthermore, the database 26 could be remotely accessed by the subject to download their personal information and progress through the method of the invention to their home-based computer. The information contained within the database 26 would remain confidential and would only be accessible by the nutritionist and the subject. In certain cases, for example, for private counseling described later, a physician may also have access to the database 26. In one example, the electronic database 26 is maintained in which data from the evaluation questionnaire is entered, the data being used to create a subject profile for private counseling. Moreover, if desired, the computer system may be accessible from the Internet either through a website and/or email.

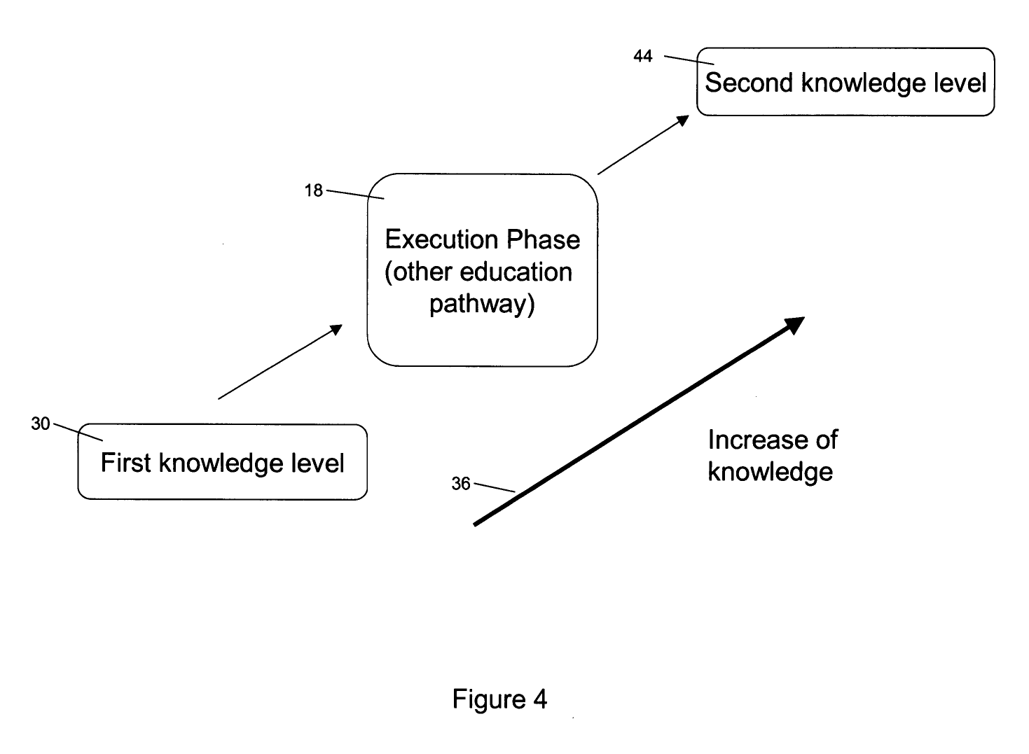

As best illustrated in FIGS. 1, 3 and 4, an integral part of the assessment phase 12 is a knowledge evaluation step 28, which evaluates the subject's knowledge of, or skills in, human nutrition science to establish a first knowledge (or skill) level 30 and a first knowledge (or skill) profile, which may be stored in the database for later reference thereto. Evaluating the subject's knowledge (or skill) is done using an evaluation questionnaire or grid 32 and is typically carried out under the supervision of the nutritionist. The questionnaire 32 is designed to score the subject on basic general knowledge of, or skills in, health issues and nutrition science; each of the health issues may be color coded to enable easy evaluation by the nutritionist. Once completed, the questionnaire 32 provides scores for the subject on health issues and nutrition science, for example but not limited to, basic anatomy and physiology, medicine, nutrition science, food choices and eating pleasures. Within each issue on the questionnaire 32, a number of knowledge criteria are evaluated, for example, under the issue of eating pleasures, the subject is assessed on their knowledge of, or skills in, meal evaluation, spices, herbs and the like. Additional features of the questionnaire 32 may include questions concerning the subject's motivation to be enrolled in the method of the present invention. Typical responses to the subject's motivation may be physician directed advice, peer pressure, a desire for further education, recreation activity, and the like. Upon completion of the assessment phase 12, the subject is provided with a score, which correlates with their first knowledge level 30, as best illustrated in FIG. 4. The results of the assessment phase 12 are then electronically entered into the electronic database 26. This signals the end of the assessment phase 12. As a reference point, the database 26 may also include an idealized knowledge profile of the subject to which all future progress of the subject may be measured and matched. The idealized knowledge (or skill) profile may be based on the subject's age, sex, and general education level, and may be used as a guide or an achievable goal in some cases. A nutritional assessment may also performed in which there is a nutritional evaluation, a medical history evaluation, a family medical history evaluation, a weight evaluation, a height evaluation, a Body Mass Index (BMI) evaluation, a nutritional risk evaluation and a nutritional status evaluation of the subject. This acts as a guide to the nutritionist, who may decide on the treatment plan for subjects in need of private counseling.

Still referring to FIG. 1, and depending on the needs of the subject, there next follows the program choice phase 14, the payment phase 20, and the enrollment phase 16. The program choice phase 14 is the step during which the subject decides whether to enroll either in a round table education session 34; a first nutrition education pathway 36 in accordance with the present invention; or a private counseling 38. The private counseling choice 38 is typically designed for subjects who have specific health care needs that require specialist dietary education, for example, subjects suffering from diabetes, and will be described in detail below. Once the subject has chosen their desired route, they are enrolled in the session 34, the pathway 36, or the choice 38, and then they move to the execution phase 18. Within the first education pathway choice 36, the subject may choose from either a private session pathway 40 or a group session pathway 42. The selection within the program choice phase 14 is electronically entered into the electronic database 26.

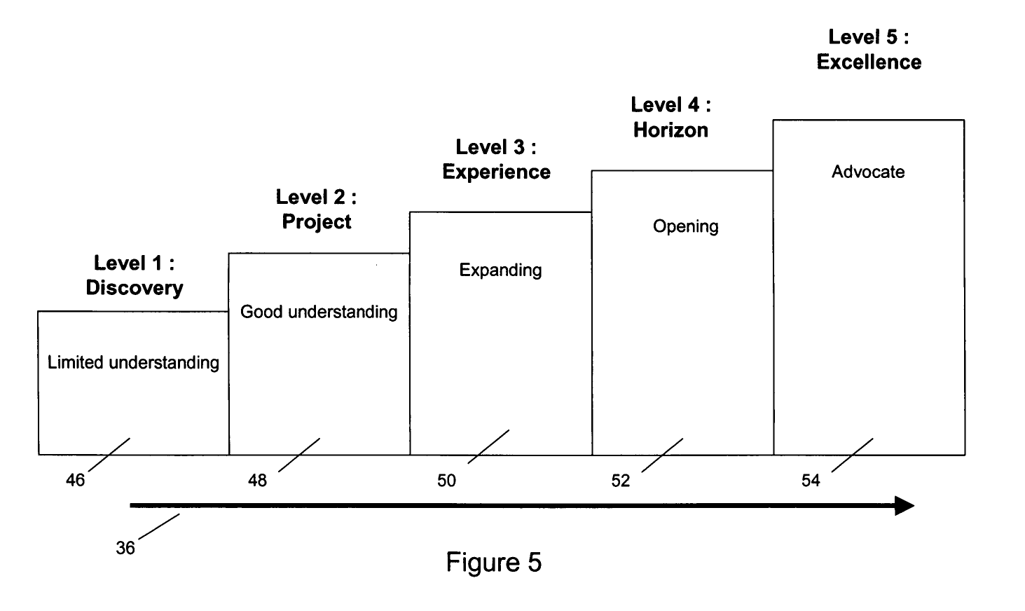

Referring now to FIGS. 1 and 4, both the private session pathway 40 and the group session pathway 42 are designed to progressively increase the nutrition science knowledge and skills of the subject from the first knowledge (or skill) level 30 to a second, higher, knowledge (or skill) level 44 through the first nutrition education pathway 36 within the execution phase 18. The first pathway 36 comprises one or more and twenty or less knowledge (or skill) levels of increasing sophistication. Typically, the first pathway 36 comprises one or more and ten or less knowledge (or skill) levels. In the example illustrated, the first pathway 36 consists of five levels 46, 48, 50, 52, and 54 respectively labeled as Discovery, Project, Experience, Horizon and Excellence. Each level from level 46 up to level 54 has an increasing level of knowledge (or skill) sophistication that is achieved by the subject as they move along the first pathway 36. As best illustrated in FIGS. 4 and 5, the level 46 corresponds to the first knowledge (or skill) level 30 of the subject and the highest knowledge (or skill) level (or second knowledge (or skill) level 44) corresponds to the level 54.

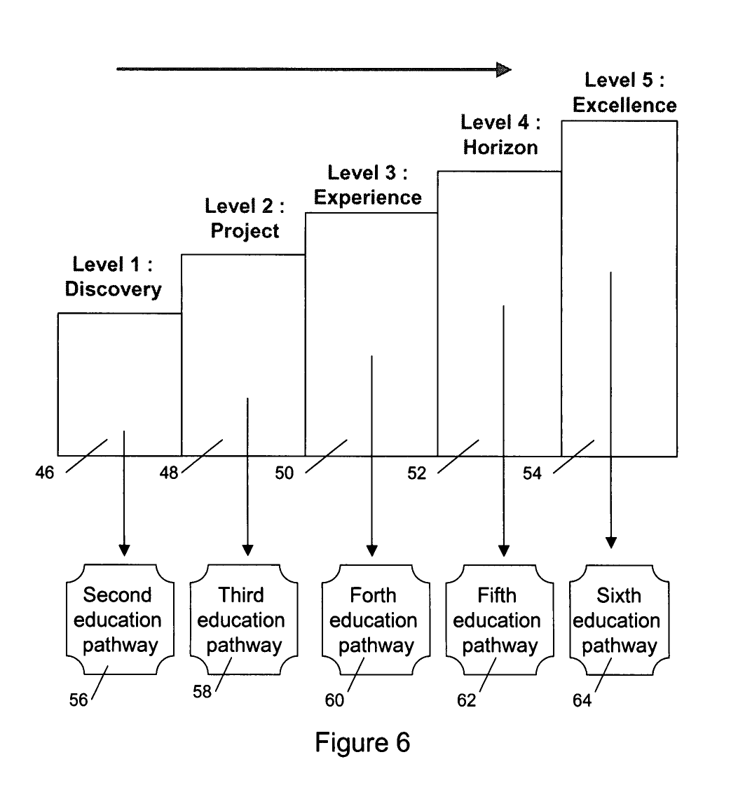

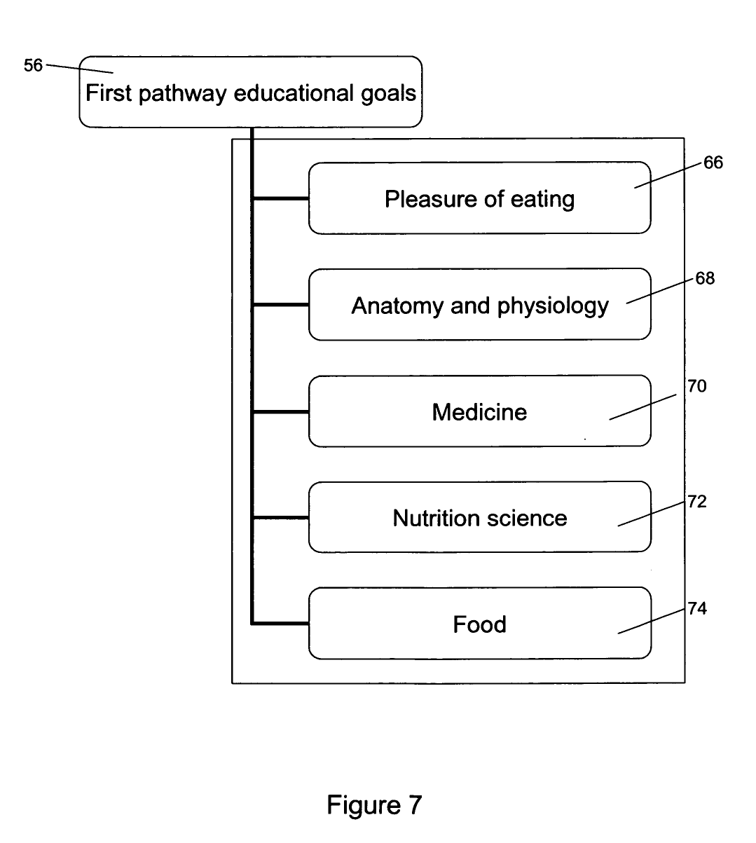

Referring now to FIGS. 6 and 7, each of the levels 46, 48, 50, 52 and 54 further comprises respectively a second nutrition education pathway 56, a third nutrition education pathway 58, a fourth nutrition education pathway 60, a fifth nutrition education pathway 62, and a sixth nutrition education pathway 64, each of which operates simultaneously and progressively with the first education pathway 36. Each of the pathways 56, 58, 60, 62 and 64 includes a number of educational goals 66, 68, 70, 72, and 74. For ease of representation only the education goals in the second nutrition education pathway 56 are illustrated in FIG. 7.

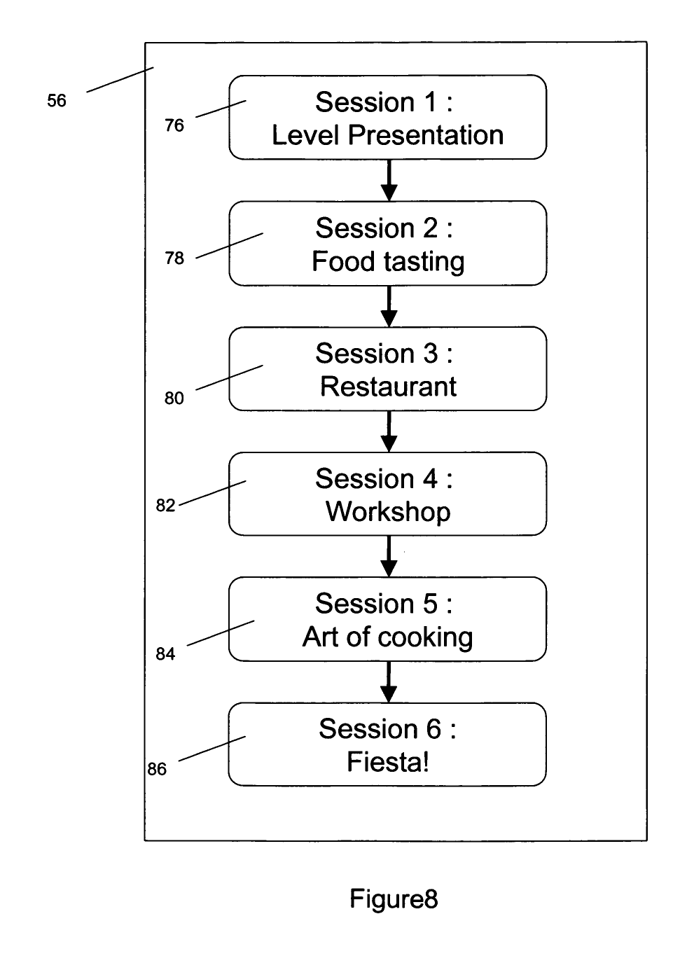

Referring now to FIG. 8, the steps of the second pathway 56 include a level presentation session 76, a food tasting session 78, a restaurant session 80, a workshop session 82, an art of cooking session 84 and a fiesta session 86. The educational goals 66, 68, 70, 72, and 74 are the prime objective for the aforesaid sessions to complete a level of the first nutrition education pathway 36. A more detailed description of the operation of the pathways is described below

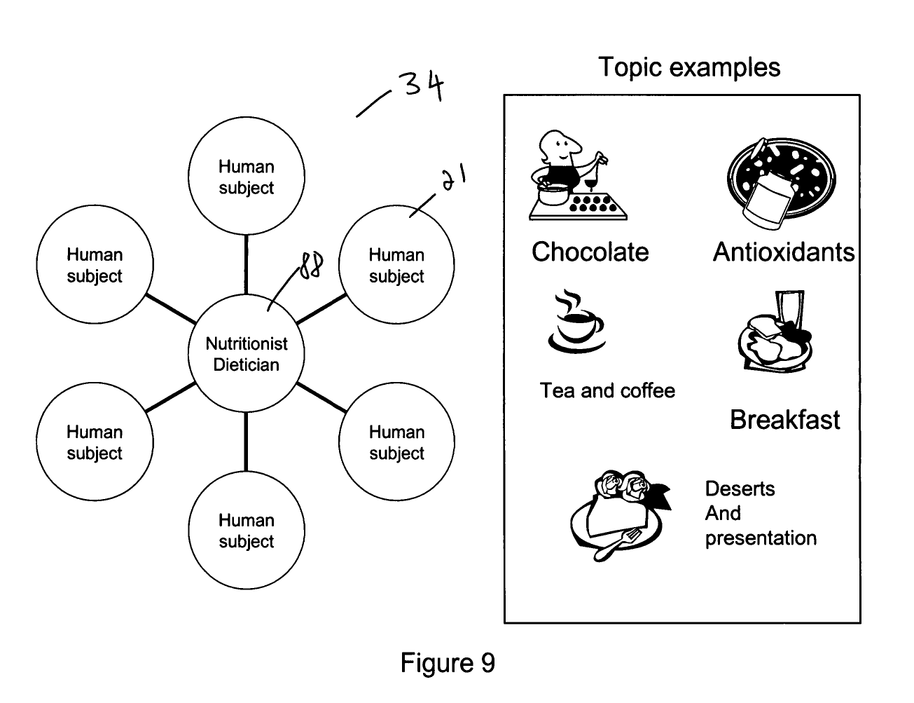

As an alternative to being enrolled in the first education pathway 36, the subject may choose a more conventional method of nutrition education. Referring again to FIG. 1 and now to FIG. 9, a round table education session 34 may be selected to address specific topics, for example, chocolate, vitamins, tea/coffee, breakfast and deserts and the like, on a regular basis, in a group discussion with a nutritionist 88, for subjects 21 who do not necessarily wish to enroll in the nutrition education pathway 36, but who wish to discuss specific topics related to nutrition science.

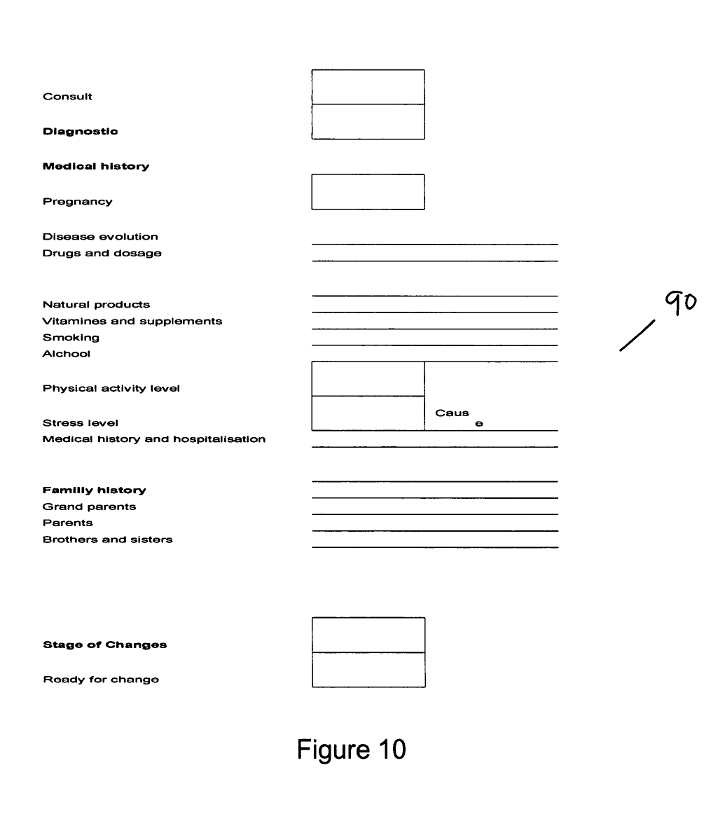

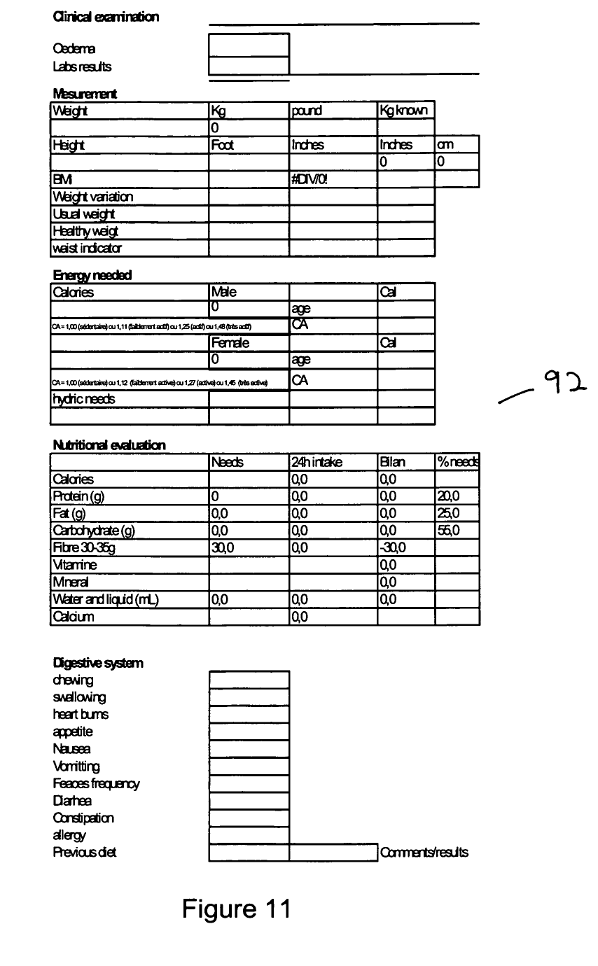

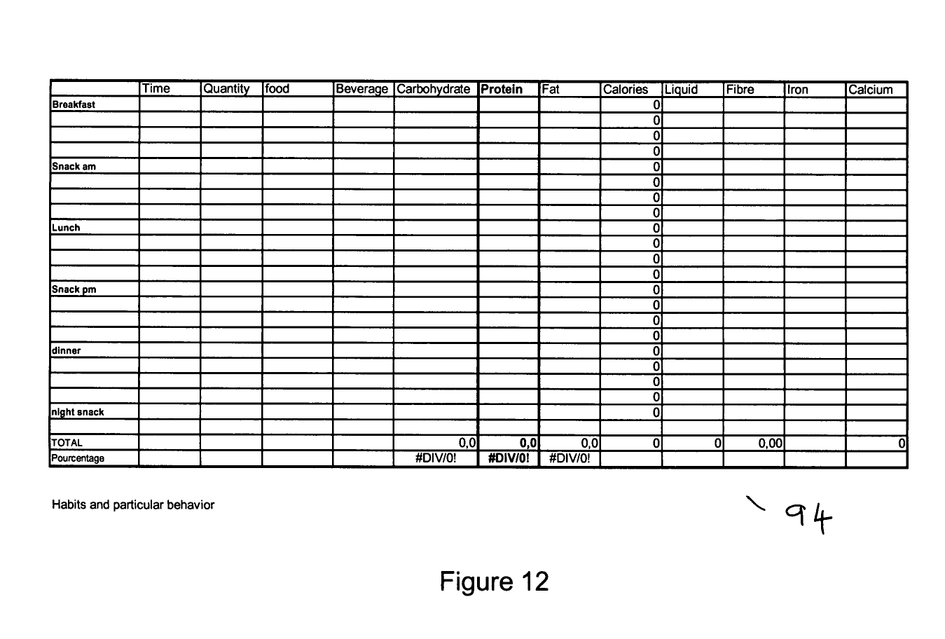

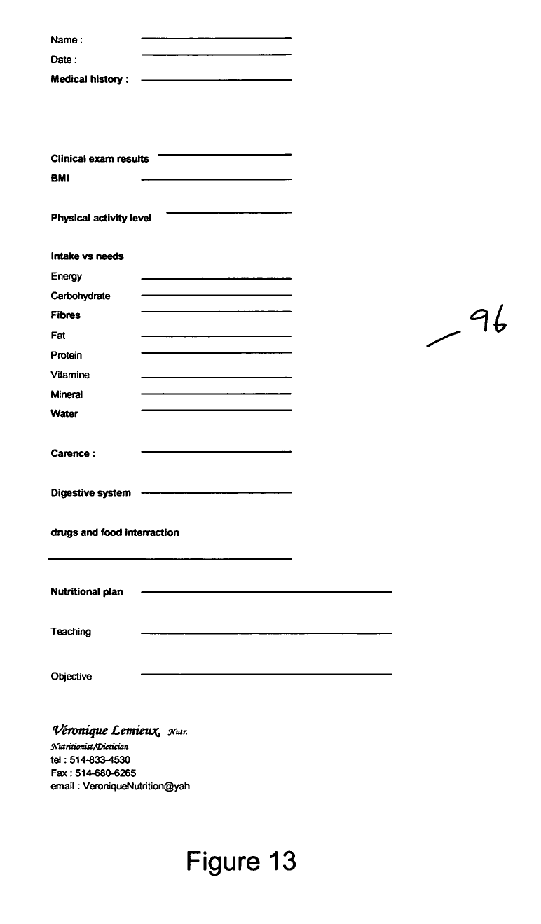

As another alternative, a private counseling choice 38 is specifically designed to counsel subjects, either individually or with family members, who have specific health issues such as, for example, diabetic patients, who may have been referred to the nutritionist by their physician. Typically, specific dietary education is required by the subject since unhealthy food choices may promote adverse health emergencies or even death. Referring now to FIGS. 10 through 13, once enrolled in the private counseling choice 38, the subject's general health and current food choices are evaluated using a consultation form 90, a clinical examination form 92, a journal of food intake 94 and a subject analysis form 96. The contents of the forms 90, 92, and 94 are entered into the electronic database 26 by the nutritionist, the contents of which may be accessible to the subject's physician so that he or she may monitor the progress of the subject through the method of the invention. The subject's nutritional education requirements are then recommended and given to the subject at each session in a regular nutritional consultation form. The subject could be offered, separately to enroll in the nutrition education pathway to increase his/her knowledge (or skill) as a bonus to their private consultations.

Advantageously, the methods of the present invention may be accessible remotely by the subject using, for example, videoconference or a webeam. The remote access may also be fully interactive so that the subject may participate in the method whilst away from the home or the classroom.

Operation

The method of the present invention will now be described in more detail with reference now to FIGS. 1, 6, 7 and 8. Broadly speaking, each of level 1 through 5 comprises a number of educational goals 66, 68, 70, 72, and 74. Typically, there are five educational goals within each level, although one skilled in the art will readily understand that more than five goals or less than five goals may be required and may be customized for each of the subject's needs.

I Group First Nutrition Education Pathway 42

Typically the group includes two or more subjects who wish to derive an enhanced. learning experience as part of a social interaction between them and the dietician or nutritionists. The group may include a mixture of individuals, couples, singles, family members, in need of family-orientated education, and the like. Group spirit is typically achieved through interactions of the subjects in group activities during which the subjects build a team spirit with the same educational goals as with the private session described below. Part of the team-building exercise is to provide a fun and pleasurable learning environment in which the team is given an identity such as a team symbol.

Level 1 (“Discovery”)

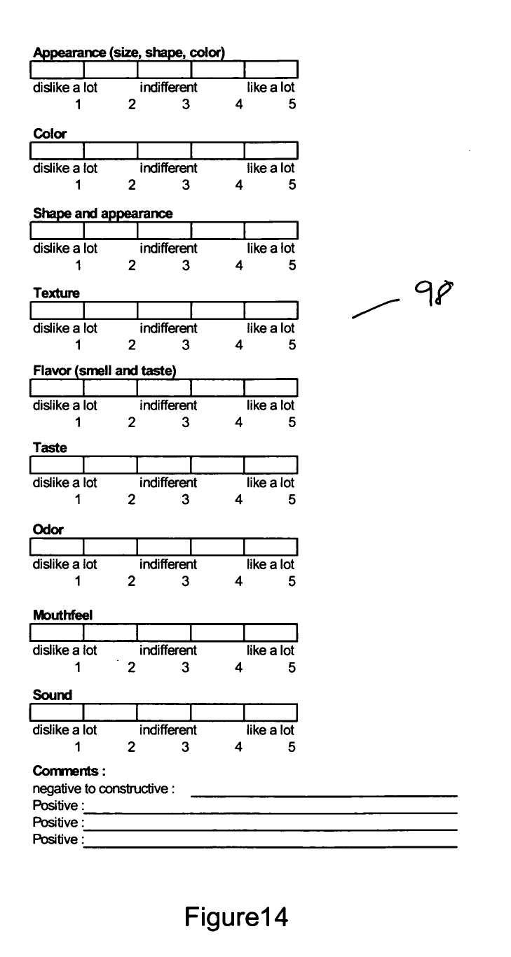

The goal of level 1 46 is typically designed for subjects who have achieved a low score in their assessment phase. Typically a score between 0-1 would warrant enrollment in level 1 46. The low score would indicate that the subject has a limited understanding of anatomy, physiology, medicine, nutrition science (for example: a poor understanding of the nutritional value of foodstuff), and the pleasure of eating. The subject who has this low score would typically be at a higher risk of developing illnesses such as obesity, diabetes, coronary heart disease and certain types of cancers, and who would benefit the most from being enrolled in level 1. The objectives for the subject once enrolled in level 1 are to understand the impact of food choices on his or her health and to be better able to evaluate the experience of eating, whether it be pleasurable or non-pleasurable. Level 1 comprises the second pathway 56 which includes five sessions namely the level presentation session 76, the food tasting session 78, the restaurant session 80, the workshop session 82, the art of cooking session 84 and the fiesta session 86, the sessions being based on achieving the educational goals. The pleasure of eating goal 66 involves the subject understanding a food evaluation grid 98, according to FIG. 14, and to evaluate a meal with it. The subject will also discover the four basic tastes: sweet, salt, bitter, and acid, and distinguish the location of each taste on their tongue. The results of the tasting test are electronically entered into the electronic database 26.

The anatomy and physiology education goal 68 is a basic introduction to the general component parts of the human body such as cells, tissues, skin, and certain basic regulatory systems such as homeostasis and the digestive system.

The medicine education goal 70 focuses on a definition of what constitutes good health. The subject is exposed to certain disease and risk factor recognition, the role of hospitals in society, and scientific studies on health issues such as obesity, its component and credibility.

The nutrition science education goal 72 focuses on educating the subject in what are macronutrients, specifically, energy, carbohydrates, fat and protein. Furthermore, the subject is given a basic lesson on the use of the Body Mass Index (BMI) and the idea of a healthy weight loss through behavior modification, avoiding food restrictions, and increasing nutrition science education knowledge and exercise. The lesson also focuses on the issues of diarrhea, constipation and how these are indicators of a healthy digestive system and diet.

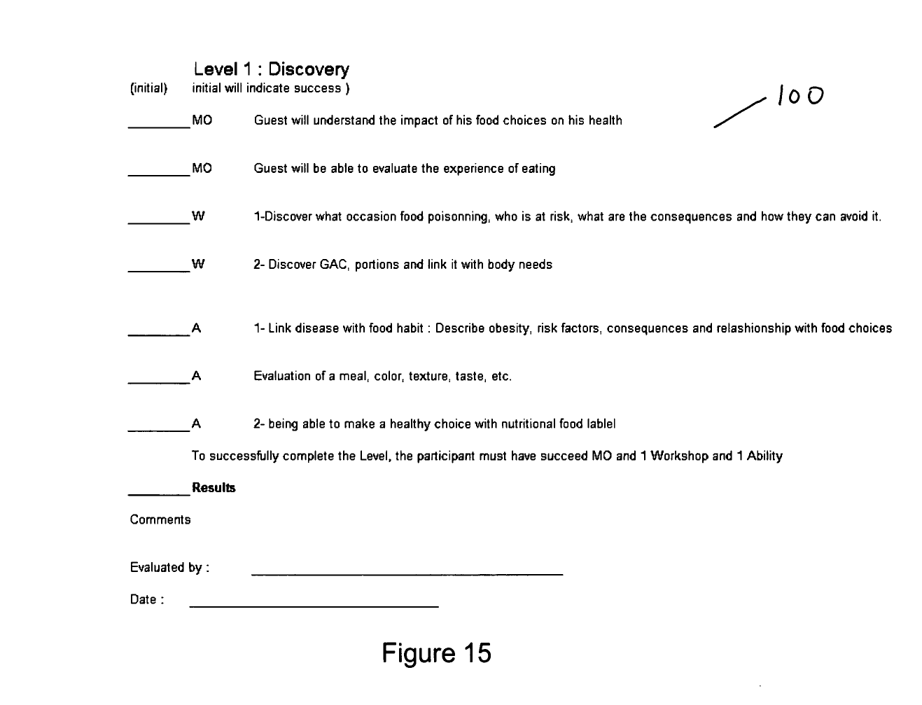

The food education goal 74 of level 1 focuses on providing the subject with the skills to correctly and critically read nutritional content labels on food items, the hygiene of food preparation and the joy and art of cooking. Once the nutritionist is satisfied with the subject's progress in level, typically based on the subject's participation level, progress and understanding, the subject may now enroll in level 2. Referring now to FIG. 15, to evaluate the subject's suitability to progress to level 2, the nutritionist uses a progress evaluation grid 100 to assess the subject. If required to complete a level, a private consultation may be offered to the subject.

Level 2 (“Project”)

Level 2 48 comprises several lessons based on specified categories of educational goals. The goal of level 2 48 is to provide the subject with a good understanding of human anatomy, physiology, medicine, and nutrition science, and the nutritive value of food and the pleasure of eating healthy. Typically a score of between 1-2 from step 28 would warrant enrollment in level 2. Aside from inherent familial issues such as a genetic predisposition towards a certain medical condition which are beyond the control for the subject, the subject has knowledge of, or skills in, factors which are within their control, such as diet. The objective of level 2 would be to enable the subject to make healthier food choices with an increased knowledge and competence.

Level 2 comprises the third pathway 58, which includes the same steps as with the second pathway 56, which were described for level 1, except that the level of sophistication increases. In level 2, the pleasure of eating goal 66 would be to increase knowledge about spices and herbs used in cooking for the subject to enjoy and develop new tastes. This will also be a tool to add flavor to their meals instead of using, for example, salt, which may lead to health problems.

The anatomy and physiology goals 68 are designed to focus the subject's attention on one portion of human anatomy and physiology. One such portion includes basic education on the function of the muscles, urinary system and cardiovascular system. The medicine education goal 70 is now correlated with the human anatomy and physiology education goals, and seeks to increase the subject's knowledge of cardiovascular disease, hypertension, exercise and the role of proper hydration in maintaining healthy system function. The aforesaid educational goals of level 2 would be achieved using typical teaching apparatus, such as simple charts, diagrams, human figure models and the like, all with an emphasis on interactive learning between the subject, the nutritionist and the apparatus.

The nutrition science education goal 72 in level 2 builds on the aforesaid goals by seeking to improve the subject's knowledge of, or skills in, nutrition science. This education goal focuses on the issues of body fat (cholesterol, LDL-cholesterol, HDL-cholesterol, triglycerides, and the like), the function of exercise and fiber on the cardiovascular and digestive health and the adverse effect of salty foods on the body. The final education goal of level 2 builds on the food education goals 74 of level 1 and seeks to educate the subject on foodstuff containing unsaturated fat, fiber, and food with very high salt content to help them make healthy choices.

Level 3 (“Experience”)

Level 3 50 comprises the fourth pathway 60 which includes the same steps as described for levels 1 and 2, except that the level of sophistication of knowledge obtained by the subject increases compared to level 2 knowledge. The goal of level 3 50 is to provide the subject with a more sophisticated knowledge compared to level 1 and level 2. Specifically, level 3 seeks to help the subject to make restricted changes in food habits and to experience the pleasure of eating a healthier diet. Subjects who enroll in level 3 or are deemed sufficiently competent after completing level 1 and level 2, or may enroll directly if they have achieved a score of between 3-4. The objectives of level 3 is to arm the subject with sufficient basic knowledge to now make different and healthier food choices compared to when they first enrolled in the method of the present invention, and to acknowledge that the pleasure of eating healthier foods can be correlated with a pleasurable experience. The pleasurable experience education goal 66 in level 3 focuses on educating the subject on the different textures of food to enhance the pleasure of eating, such as mixing soft yogurt with crunchy hot granola instead of having only a simple yogurt. It can also help subjects who have developed dysphasia to see if liquid, pudding or solids are safe for them, and those patients who have lost their appetite to find ways to make a mouth feeling experience more pleasant and to increase their food intake.

The anatomy and physiology education goals 68 in level 3 focus on the nervous system, while the medicine education goals focus on issues such as heart burn, depression, anxiety, irritable bowel syndrome, and neurodegenerative disease, for example, Alzheimer's disease, multiple sclerosis, Parkinson's disease. As with level 2, this portion of the education goals can be used with typical teaching aids known to those skilled in the art.

Moreover, the education in anatomy and physiology are correlated with the medicine, correlated with nutrition science and correlated with food choice.

The nutrition science education goal 72 and the food education goal 74 is focused on providing the subject education related to the medicine goal. Specifically, the nutrition science goal 72 would be to educate the subject on calcium intake related to a good function of the nervous system, carbohydrate, protein and tryptophan, and the relation with humor and sleep disorder, deficiency consequences with a low intake of food related to neurodegenerative disease, and finally to educate the subject about the role of fiber in bowel diseases. As for the food goal, it is to help the subject find food with calcium, protein, carbohydrate, fiber, and tips on how to avoid heart burn, and how to increase energy intake with food such as adding milk powder to a recipe.

Level 4 (“Horizon”)

Level 4 52 comprises the fifth pathway 62 and includes steps again which are identical to level 3 and seeks to build on the knowledge or the skills, the subjects who have satisfied the educational requirements in level 3, and is available to subject who scored between 3-4. The subject who enrolls in level 4 is now comfortable with the concept of healthy food choices and can now correlate the experience of pleasurable eating with healthy food choices. The objective of level 4 is to provide an increase in sophistication in the subject's knowledge.

In level 4, the pleasure of eating education goal 66 focuses on dessert as a pleasant experience, such as discovering new desserts, new presentation, and how to make it a healthy experience as well. Poor dessert selection is often a major contributor to weight gain in children and adults. Typically, desserts provide little or no nutritional benefit to the subject and are often high in fat and sugar content. By exposing the subject to a number of dessert experiences, their knowledge of pleasure of eating based on their new skills to evaluate taste and texture from the previous levels is moved beyond savory dishes, and provides the subject with a broader knowledge base of healthy food choices.

The anatomy and physiology education goals 68 in level 4 focus on related subjects such as diabetes, pregnancy, and bones and joint diseases, such as arthritis and osteoporosis.

The medicine education goals 70 focus on diabetes, pregnancy, bone and joint diseases, such as arthritis and osteoporosis.

The nutrition science and food education goals 72, 74 focus on carbohydrates and fat with their impact on blood lipid level to prevent obesity, diabetes and the like, and the role of healthy eating during pregnancy. The subject is educated on the role of calcium on the developing fetus during pregnancy or its role in preventing osteoporosis, as an example. Specifically, the subject is educated as to which foods provides carbohydrate and fiber, fat and unsaturated fat, and calcium.

Level 5 (“Excellence”)

Level 5 comprises the sixth pathway 64 and is for subjects who achieved a score of between 4-5. It is typically available to those subjects who have successfully completed level 4. Once completed, level 5 subjects are considered experts in nutrition science knowledge and ability to make good healthy food choices and may become advocates for the method. The subjects who satisfy the requirements of level 5 typically have made a complete lifestyle change to healthy nutritional habits. Level 5 subjects may now have incorporated an exercise regime into their daily activities based on their knowledge gained from the previous levels. Moreover, level 5 are able to take more of a proactive role in their overall health and influence people around them, such as relatives.

The objective of level 5 is to have the subject make food choices for health and pleasure everyday with the knowledge that they can confidently and competently make the correct food selection using the knowledge acquired from levels 1 through 5. The pleasure of eating education goal 66 focuses on international food and cuisine to discover new food, meals, spices, meal presentations, taste and the like.

The anatomy and physiology education goals 68 is more sophisticated than levels 3 and 4, and focus on immunology, the respiratory system, the lymphatic system, and the development of the fetus and ageing.

The medicine education goal 70 focuses on allergy-inducing food, cancer, HIV, pulmonary obstructive disease, Crohn's disease, tobacco use and the complications associated therewith.

The nutrition science and food education goals 72, 74 focus on introducing food to avoid allergy; antioxidants and their role in cancer and ageing; specific nutritional requirements of the newborn to the elderly, and people with chronic diseases such as, for example, HIV, Crohn's disease and the like.

The food educational goal 74 will relate to the nutrition science information within the level and will help the subject to identify allergenic food, to find antioxidants in food, such as vitamin E in wheat germ; to know which foods contain iron to prevent deficiencies such as anemia, and how to supplement foodstuff to increase the energy intake in chronically diseased subjects.

II Private Nutritional Pathway 40

An alternative to the group session pathway 42 is the private lesson pathway 40. The contents of the private lesson 40 are almost identical to group session 42 and may be represented also by FIGS. 1, 6, 7 and 8.

Whereas the group lesson pathway 42 is focused on disseminating information in a group atmosphere, the private lesson pathway 40 focuses on an individual subject or a smaller group of people, for example, two parents and two children, or a couple, typically with no unknown people, and with the advantage of flexibility in the schedule. The objectives, like that of Level 1 above, are to understand the complexity of the human body and health care issues that affect it. As with the group session discussed above, the subjects evaluate the pleasurable experiences of eating and begin to implement this in the home environment.

Throughout execution of the methods of the present invention, the education goals are provided in a relaxed atmosphere and involve use of visual stimuli as teaching aids, such as pictures of healthy and unhealthy meals, workshop and competency development. Simple homework exercises may include coordinating the harmony of color, texture, and taste with healthy and unhealthy food choices. The subjects may be evaluated by, for example, presentation of their homework to the class.

The restaurants step 80 provides an educational opportunity for the subjects to make healthy choices from restaurant menus, which could be a dining out activity or around a meal situation. Some of the subjects may view the dining out experience as a real life situation that contributes to compliance with the method of the invention and may act as positive feedback to the subject and foster encouragement for continued compliance with more advanced lessons 4 to 6. As with levels 1 through 6 for the private lesson pathway 40, the nutritionist is performing continual evaluation of the subjects as they progress from lessons 1 through 6. The results of the evaluation can be electronically entered into the electronic database 26 by the nutritionist.

### EXAMPLES

For a better understanding of the education goals and of the second nutrition education pathway 56 of the present invention, the following non-limiting Examples are provided, and specifically describes Level 1. It is to be understood that Levels 2 to 5 follow essentially the same format. It should be noted that although the second nutrition education pathway 56 is described below, the same descriptions also apply to the third, fourth, fifth, and sixth pathways 58, 60, 62, and 64 respectively.

Level 1: Discovery 46

Discovery: The subjects have a limited understanding of anatomy, physiology, medicine and nutrition science, nutritive value of food and pleasure of healthy eating.

| | |
|---|---|
| Average score: | 0-1 |
| Main Objective: | Subject will understand the impact of his/her food |
| | choices on his/her health; |
| | Subject will be able to evaluate the experience of |
| | eating. |
| Pleasure of | Evaluation of a meal, color, texture, taste, and the like; |
| eating 66 | Tasting test and use of the evaluation grid 98 for |
| | food tasting. |
| Anatomy & | Learn about body cell, tissues, homeostasis, skin, |
| physiology 68 | and digestive system; |
| | Learn about different body systems. |
| Medicine 70 | Learn about the definition of health, disease and |
| | risk factors; |
| | Learn about the hospital environment, scientific |
| | studies and obesity; |
| | Learn the differences between MDs, specialists, |
| | and other health care professionals. |
| Nutrition | Learn about Macronutrients (energy, |
| science 72 | carbohydrate, fat, and protein), Body mass index |
| | (BMI), healthy weight; |
| | Learn about weight loss with no restriction; |
| | Learn of the negative consequences of poor weight |
| | loss management such as diarrhea, constipation; |
| | Learn how to lose weight properly. |
| Food 74 | Learn about nutritional information label, hygiene, |
| | and art of cooking. |

Session 1: Level Introduction/introduction 76

This involves the introduction of nutritionist and subject(s) with name and favorite taste (sweet or salty) as an icebreaker. Presentation of the program, level description with main objectives and ask for guest needs and objectives, and sessions details.

Main Objective (MO):

The subject will understand the impact of his food choices on his health and will be able to understand the complexity of the body and health care system.

Team building: Team objective for the 6th lesson (have fan and learn about health and link it with nutrition food habit), team name, tag, symbol.

Workshop

1. Discover: Component, role, and physiology of body, progressively from cells, tissues, skin to digestive system. Learn definition and process of homeostasis in the human body.
2. Associate words with their definition.

Health, disease, risk factors, hospital environment, scientific studies and obesity.

Summary (Done by the Group)

First Tasting Session

Pleasure of eating: salty: crispy rice chips.

Skills Development

1-Link disease with food habit: Describe obesity, risk factors, consequences and relationship with food choices.
2- BMI education and measure by participants.
3- Be able to differentiate physiological appetite from psychological appetite.
   Second Tasting Session

Dessert: surprise mocha squares and dry fruits, discussion on portion size.

Closing:

Back to MO for measurement of the success rate of MO in group, followed by a description of session 2 to follow.

Homework:

The subject would be asked, for example, to be conscious of portion size they eat versus appetite and to name 3 positives comments about the session and comment on what they have learnt.

Session 2: Food Tasting 78

Focuses on the pleasure of eating, and evaluation of meals.

Review of first session on obesity, by group and then name risk factors and complications associated therewith.

Main Objective (MO):

The subject will be able to evaluate the experience of eating and start to implement it at home.

Workshop

1- (Part 11): Discover: Component, role, homeostasis, physiology of the body, cells, tissues, homeostasis, skin, and digestive system.
2- Education on taste four primary qualities: sweet, salty, sour, and bitter.
3. Education of the position of the taste on tongue and taste buds.

First tasting session to test tasting sweet, salty, sour, and bitter by the subject.

Summary

Skills Development

1. Identify criteria of what represents pleasure of eating.
2- Education about the evaluation grid for tasting
   a) Evaluation of a meal, color, texture, taste, and the like;
   b) Practice with pictures of meals to reiterate the education.
      Second Tasting Session:

Using evaluation grid, evaluate a snack, with a discussion in group.

Closing:

Back to MO, measure of success.

Homework:

This might involve trying to with a new notion on food tasting and pleasure of eating at home.

Everybody will share their experience the following week at a restaurant. Name 3 positives comments about the session and what they learned.

Session 3: Restaurant 80

Focuses on appetite and good table manners, art of reception, evaluation of menu, meal with the grid 98.

Review of previous: evaluation grid and home meal experience.

Main Objective (MO):

The subject will be able to evaluate the experience of eating at a restaurant.

The subject will be able to understand the menu and discover how to stop eating when they are not hungry anymore, and basic good table manners.

Workshop

1 - Group discussion about good manners at restaurant, receptions and the likes.
2- Define healthy choices at the restaurant, such as the importance of vegetables.
   First Tasting Session (for Example, Ordering Foods from Menus)

This may involve the evaluation of a meal, color, texture, taste, etc.

Skills Development

1 - Evaluate portion size vs appetite and be critical about health as seen with obesity, link with homeostasis.
2- Be conscious of the pleasure of eating during the meal.
3-Stop eating in the middle of meal to see if still hungry and when not hungry anymore stop eating.
   Second Tasting Session:

Tasting dessert.

Closing:

Back to MO, measure of success.

Homework:

The subjects would practice at home to stop eating when full and question if still hungry in the middle of the meal.

Bring two packaging of same category of food with a nutritional food label to compare for following session.

Name 3 positives comments about the session and what they learned.

Session 4: Workshop 82

Focuses on the Canadian Food Guide, portion food labeling and address weight loss.

Summary and discussion about appetite and psychological hunger.

Main Objective (MO):

The subject will acquire nutrition science knowledge, such as macronutrients (energy, carbohydrate, fat, and protein), Body mass index (BMI), healthy weight loss with no food restriction.

The subject will be comfortable with the Canadian Food Guide and portion, and be able to read food labeling.

Workshop

1 - Cycle of dieting and what is healthy weight loss, and why with it works better with no food restrictions.
2- Discover the Canadian Food Guide, portions and link it with body needs.
3- Understand nutritional food table value and portion size compare to the Canadian Food Guide and hunger.
   Summary
   First Tasting Session

High fiber snack and portion size.

Skills Development

1 - Practice with a 24h journal food intake to evaluate portion of the Canadian Food Guide.

2- being able to make a healthy choice with nutritional food label.
   Second Tasting Session

Compare and taste two different type of cookies, one with fat, no protein, no fiber versus one with a low content of fat and containing fiber.

Closing:

Back to MO, measure of success.

Homework:

Bring favorite recipe for next session. Name 3 positives comments about the session and what they learned.

Session 5: Art of cooking 84

Focuses on adapting recipes, half plate of vegetable and eat them first.

Main Objective (MO):

Understand and apply hygiene and safety laws in cooking to avoid food poisoning and contamination.

Be familiar with the basic vocabulary of cooking. Develop competencies to have a complete meal, healthy, delicious and easy.

Workshop

1-Discover what causes food poisoning, who is at risk, what are the consequences and how they can avoid it.
2- Associate words with definition related to cooking.
   Summary
   First Tasting Session

Same recipe, one almost no nutritional value, and the other healthier version, for example, JELLO™ vs JELLO™ with milk and fruits.

Skills Development

1- Make the recipe, which the subject brings into a healthier version in concordance with the knowledge acquired from previous sessions.
2- Serve a dish with (½ vegetable, ¼ protein, ¼ carbohydrate).
   Second Tasting Session:

With the grid 98, the subject would evaluate a pasta meal, such as white and whole wheat pasta with vegetable, herbs, legume, etc.

Closing:

Back to MO, measure of success.

Homework:

Evaluation with a hygiene grid (not shown) the subject's cooking environment and make changes if required.

Name 3 positives comments about the session and what they learned.

Session 6: Fiesta! 86

Summary, evaluation, wine and cheese party, casual setting and presentation of a reward such as a diploma.

Main Objective (MO):

Summary of one new concept learnt at level 1, followed by a diploma presentation and a party (wine and cheese) with a group photograph. Realize what the subjects have accomplished.

The subject will understand the impact of his food choices on his/her health and will be able to evaluate the experience of eating and start to implement it at home. Moreover, the subject will want to subscribe to second level and bring friends.

Workshop

1 - Be able to teach what they have learned in the first level to someone else
2- Define how to plan an event around food like wine and cheese.
   Group Summary

Name 3

positives comments about the session and what they learned.

Closing (Measure of Success, Emotions, Next Level Education).

Tasting Session

Wine and cheese party.

Celebration with reward and group picture with the nutritionist.

As the subject or subjects' progress through the sessions described herein, the goal of the nutritionist is to be a coach, a liaison and a translator of medical information about health issues and nutritional science into foodstuff identification for the subject so that the subjects can make healthy and educated selections of foodstuff.

One skilled in the art will understand that all of the method steps described above may be interchanged without deviating from the scope of the present invention.

### OTHER EMBODIMENTS

From the foregoing description, it will be apparent to one of ordinary skill in the art that variations and modifications may be made to the invention described herein to adapt it to various usages and conditions. Such embodiments are also within the scope of the present invention.

All publications mentioned in this specification are hereby incorporated by reference.

While specific embodiments have been described, those skilled in the art will recognize many alterations that could be made within the spirit of the invention, which is defined solely according to the following claims:

I claim:

1. An educational method for increasing a subject's skills in human nutrition science from a first low skill level to a second high skill level, the method comprising:
a) enrolling the subject in a first education pathway having one or more skill levels therein, each skill level having one or more educational goals associated therewith, the skill levels increasing as the subject progresses along the first education pathway;
b) providing the subject with at least a second education pathway, the second education pathway operating simultaneously and progressively with the first education pathway, the second education pathway having associated therewith at least one nutrition educating session adapted to achieve at least one of the educational goals, the successful completion of the educational goal allowing the subject to move to the next skill level in the first education pathway, thereby increasing the subject's skills in human nutrition science.

2. The method, according to claim 1, further including evaluating the subject's successful completion of the education goal by:
a) providing the subject in the at least a second education pathway having therein a main objective, at least one workshop, and a skills assessment, the successful completion of the main objective, the workshop, and the skills assessment being sufficient to allow the subject to move from the first skill level to the second skill level.

3. The method, according to claim 2, in which the subject is assessed using a progress evaluation grid.

4. The method, according to claim 1, in which an evaluation questionnaire is used to determine the first skill level of the subject.

5. The method, according to claim 1, in which an electronic database is maintained in which data from an evaluation questionnaire is entered, the data being used to determine the first skill level of the subject.

6. The method, according to claim 1, in which an electronic database is maintained in which data from an evaluation questionnaire and/or nutritional assessment are entered, the data being used to create a subject profile.

7. The method, according to claims 4, 5 and 6, in which the evaluation questionnaire scores the subject on skills in human nutrition science, the skills including nutrition, human anatomy and physiology, medicine, food choice, or eating pleasure.

8. The method, according to claim 7, in which the score is entered into the database, the score correlating with the subject's first skill level.

9. The method, according to claim 5, in which the database includes an idealized skill profile to which the first skill level is compared.

10. The method, according to claim 6, in which the nutritional assessment comprises a nutritional evaluation, a medical history evaluation, a family medical history evaluation, a weight evaluation, a height evaluation, a Body Mass Index (BMI) evaluation, a nutritional risk evaluation and a nutritional status evaluation of the subject.

11. The method, according to claim 1, in which the first education pathway includes a group lesson or a private lesson.

12. The method, according to claim 1, in which the first education pathway includes two or more and twenty or less nutritional skill levels.

13. The method, according to claim 1, in which the first education pathway includes two or more and twenty or less nutritional skill levels, the skill levels increasing in sophistication as the levels increase.

14. The method, according to claim 1, in which the first education pathway includes five levels of nutritional skill, the subject acquiring increased skills as they progress along the first education pathway.

15. The method, according to claim 1, in which the first education pathway includes five levels of nutritional skill, at least one of the levels including the at least one second education pathway.

16. The method, according to claim 1, in which the first education pathway includes five levels of nutritional skill, each of the five levels further including respectively third, fourth, fifth and sixth education pathways.

17. The method, according to claim 15, in which each level includes a level main objective.

18. The method, according to claim 1, in which the first education pathway includes five levels of nutritional skill, each of the five levels including five education pathway goals.

19. The method, according to claim 16, in which the education pathway goals include pleasure of eating, human anatomy and physiology, medicine, nutrition science and food knowledge.

20. The method, according to claim 1, in which the second education pathway includes at least one education session.

21. The method, according to claim 20, in which the second nutrition education pathway includes six education sessions.

22. The method, according to claim 20, in which each education session includes a session main objective.

23. The method, according to claim 20, in which each session further includes first and second tasting sessions, a skills development, homework, and a workshop.

24. The method, according to claim 1, in which the skill of the subject is measured by the subject's ability to read and understand a nutritional information label on a food product so as to make a healthy food choice.

25. An educational method for increasing a subject's skills in human nutrition science, the method comprising:
a) providing an evaluation questionnaire to the subject;
b) electronically creating a subject database by electronically adding a subject's responses to the evaluation questionnaire stored in the database;
c) electronically creating a first skill profile of the subject by analyzing the responses to the questionnaire;
d) enrolling the subject in a first nutrition education pathway based on the first skill profile;
e) providing the subject with at least a second education pathway, the second education pathway operating simultaneously and progressively with the first education pathway, the second education pathway having associated therewith at least one nutrition educating session adapted to achieve at least one of the educational goals;
f) electronically maintaining the subject's database by electronically inputting the subject's achievements of the at least one educational goal, the subject achieving a second skill profile; and
g) comparing the subject's first skill profile with the second skill profile, an increase in the nutritional skill of the subject being an indication of increased skill in human nutrition science.

26. The method, according to claim 25, in which an evaluation questionnaire is used to determine the first skill level of the subject.

27. The method, according to claim 25, in which an electronic database is maintained in which data from an evaluation questionnaire is entered, the data being used to determine the first skill level of the subject.

28. The method, according to claim 25, in which an electronic database is maintained in which data from an evaluation questionnaire and/or nutritional assessment are entered, the data being used to create a subject profile.

29. The method, according to claims 26, 27, and 28 in which the evaluation questionnaire scores the subject on skill of human nutrition science, the skill including nutrition, human anatomy and physiology, medicine, food choice, or eating pleasure.

30. The method, according to claim 29, in which the score is entered into the database, the score correlating with the subject's first skill level.

31. The method, according to claim 28, in which the database includes an idealized skill profile to which the first skill level is compared.

32. The method, according to claim 25, in which the first education pathway includes a group lesson or a private lesson.

33. The method, according to claim 28, in which the nutritional assessment comprises a nutritional evaluation, a medical history evaluation, a family medical history evaluation, a weight evaluation, a height evaluation, a Body Mass Index (BMI) evaluation, a nutritional risk evaluation and a nutritional status evaluation of the subject.

34. The method, according to claim 25, in which the first education pathway includes two or more and twenty or less nutritional skill levels.

35. The method, according to claim 25, in which the first education pathway includes two or more and twenty or less nutritional skill levels, the skill levels increasing in sophistication as the levels increase.

36. The method, according to claim 25, in which the first education pathway includes five levels of nutritional skill, the subject acquiring an increased skill as they progress along the first education pathway.

37. The method, according to claim 25, in which the first education pathway includes five levels of nutritional skill, at least one of the levels including the at least one second education pathway.

38. The method, according to claim 25, in which the first education pathway includes five levels of nutritional skill, each of the five levels further including respectively third, fourth, fifth and sixth education pathways.

39. The method, according to claim 34, in which each level includes a level main objective.

40. The method, according to claim 25, in which the first education pathway includes five levels of nutritional skill, each of the five levels including five education pathway goals.

41. The method, according to claim 40, in which the education pathway goals include pleasure of eating, human anatomy and physiology, medicine, nutrition science and food knowledge.

42. The method, according to claim 25, in which the second education pathway includes at least one education session.

43. The method, according to claim 42, in which the second nutrition education pathway includes six education sessions.

44. The method, according to claim 38, in which each education session includes a session main objective.

45. The method, according to claim 42, in which each session further includes first and second tasting sessions, a skills development, homework, and a workshop.

46. The method, according to claim 25, in which the skill of the subject is measured by the subject's ability read and understand a nutritional information label on a food product so as to make a healthy food choice.

47. A computer-readable storage medium having a data storage material encoded with the computer implemented steps of b), c) and f), according to claim 25.

48. A computer system for generating a human nutrition science skill profile of a subject, the system comprising: a computer readable storage medium including a data storage material encoded with the computer implemented steps of b), c), and f), according to claim 25; a memory for storing instructions for processing the data; a central processing unit coupled to the computer-readable storage medium for processing the computer readable data into the nutritional skill profile of the subject; and a display unit coupled to the central processing unit for displaying the profile.

49. An educational system for increasing a subject's knowledge of human nutrition science, the system comprising: a computer readable storage medium for implementing steps of b), c) and f), according to claim 25; a memory for storing instructions for processing the data; c) a central processing unit coupled to the computer-readable storage medium for processing the computer readable data into the nutritional skill profile of the subject; a display unit coupled to the central processing unit for displaying the profile; and means for providing feedback to the subject to allow them to participate in a third, fourth, fifth or sixth nutrition education pathway.

50. The computer system, according to claim 48, is accessible from the Internet.

51. An educational system for increasing a subject's skill in human nutrition science, the system comprising:
a) an evaluation questionnaire for evaluating a first nutritional skill level of the subject;
b) an electronic database for electronically maintaining the skill level profile for the subject, the database having therein an idealized skill profile;
c) a first education pathway having one or more skill levels therein, each skill level having a plurality of educational goals associated therewith, the skill levels increasing as the subject moves along the first education pathway;
d) a second education pathway, the second education pathway operating simultaneously with the first education pathway, the second education pathway having associated therewith at least one nutrition educating session adapted to achieve the educational goals, the successful completion of the goals being compared to the idealized skill profile, the matching of which allows the subject to move to the next skill level in the first education pathway, thereby increasing the subject's skill in human nutrition science.

52. An education method for improving dietary habits of a human subject, the method comprising:
a) enrolling the subject in a first education pathway having one or more skill levels therein, each skill level having one or more educational goals associated therewith, the skill levels increasing as the subject progresses along the first education pathway;
b) providing the subject with at least a second education pathway, the second education pathway operating simultaneously and progressively with the first education pathway, the second education pathway having associated therewith at least one nutrition educating session adapted to achieve at least one of the educational goals, the successful completion of the educational goal allowing the subject to move to the next skill level in the first education pathway, thereby improving the subject's dietary habits.

53. The method, according to claim 52, in which the improvement of dietary habits are measured by weight loss, improved weight management,, cholesterol management, diabetes management, or prevention of cancer.

54. The method, according to claims 1, 25 or 52, being remotely accessible.

55. The method, according to claim 54, in which the remote access is interactive.

56. The method, according to claim 54, in which the remote access is by a webcam or video conference.
